(19) United States
(12) Patent Application Publication
(10) Pub. No.: US 2017/0112091 A1
(43) Pub. Date: Apr. 27, 2017

(54) Animal Feeding System

(71) Applicant: Delilah Toussaint, Coboconk (CA)

(72) Inventor: Delilah Toussaint, Coboconk (CA)

(21) Appl. No.: 14/921,135

(22) Filed: Oct. 23, 2015

(51) Int. Cl. A01K 1/035; A01K 5/01

(52) U.S. Cl. CPC A01K 1/0356; A01K 5/0142

(57) ABSTRACT

An animal feeding system includes a cage that may house an animal. The cage has a front wall and the front wall has an opening. A housing is removably coupled to the cage. The housing is aligned with the opening and the housing may be accessible to the animal. The housing may insertably receive a bowl thereby facilitating the animal to eat from the bowl. A door is hingedly coupled to the housing. The door is positionable in a closed position and the door may retain the bowl within the housing.

### BACKGROUND OF THE DISCLOSURE

### Field of the Disclosure

The disclosure relates to feeding devices and more particularly pertains to a new feeding device for facilitating an animal in a cage to be fed remotely.

### SUMMARY OF THE DISCLOSURE

An embodiment of the disclosure meets the needs presented above by generally comprising a cage that may house an animal. The cage has a front wall and the front wall has an opening. A housing is removably coupled to the cage. The housing is aligned with the opening and the housing may be accessible to the animal. The housing may insertably receive a bowl thereby facilitating the animal to eat from the bowl. A door is hingedly coupled to the housing. The door is positionable in a closed position and the door may retain the bowl within the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a animal feeding system according to an embodiment of the disclosure.

FIG. 2 is a back perspective view of an embodiment of the disclosure.

FIG. 3 is a back view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DESCRIPTION OF THE PREFERRED EMBODIMENT

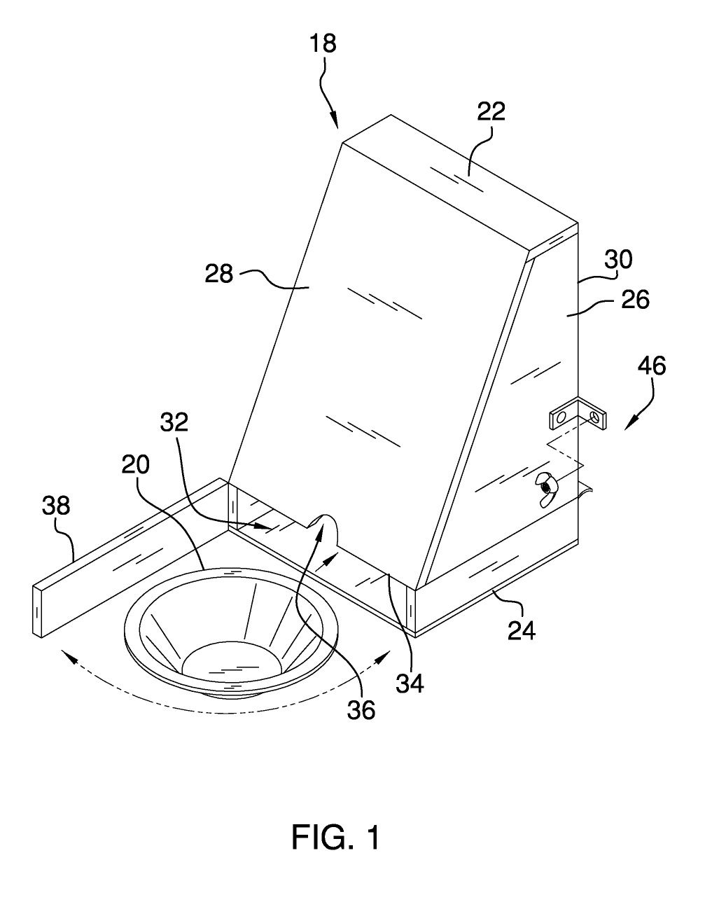

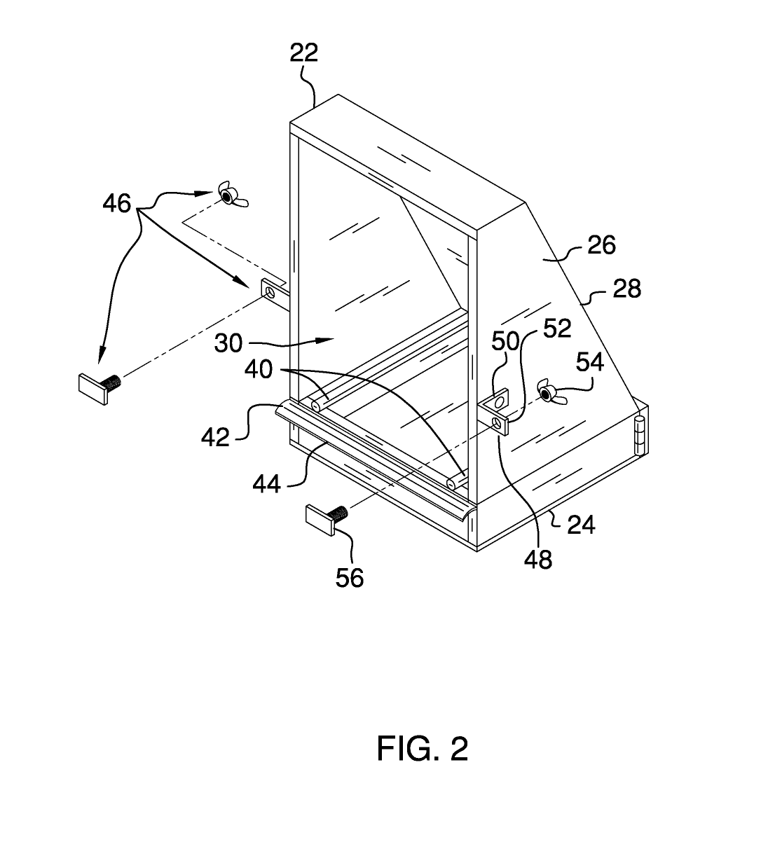

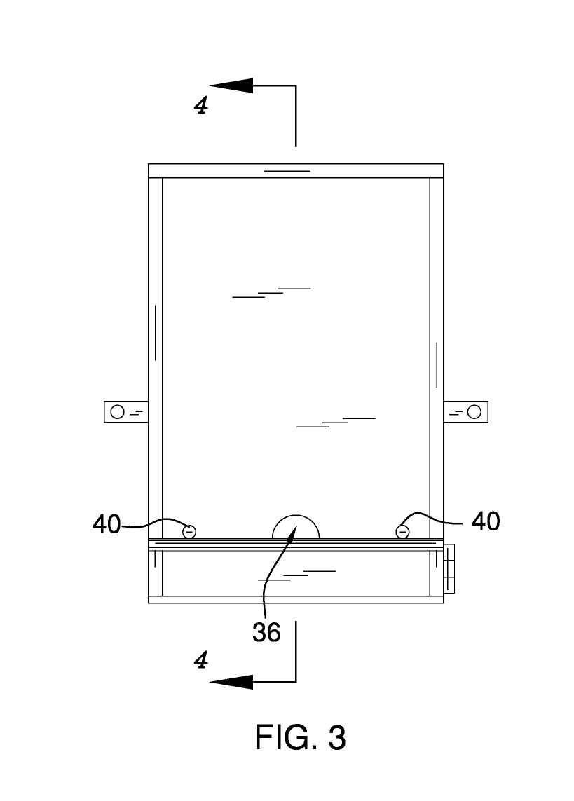

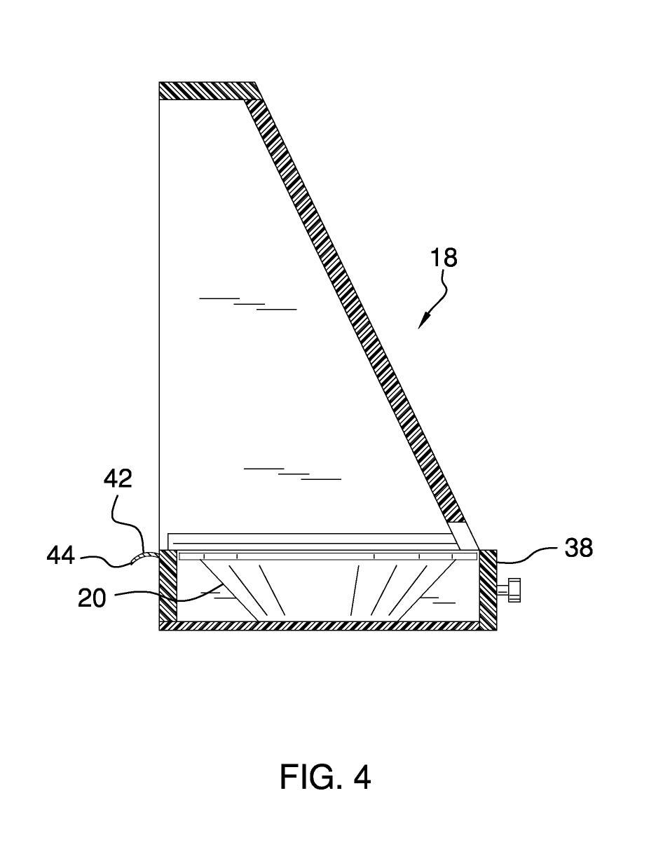

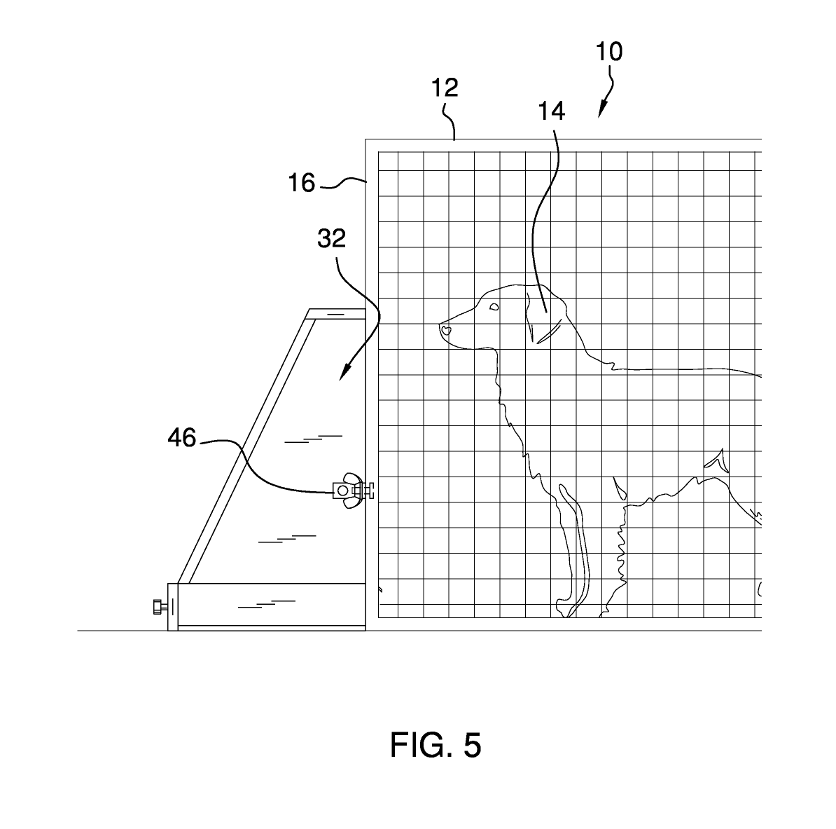

With reference now to the drawings, and in particular to FIGS. 1 through 5 thereof, a new feeding device embodying the principles and concepts of an embodiment of the disclosure and generally designated by the reference numeral 10 will be described.

As best illustrated in FIGS. 1 through 5, the animal feeding system 10 generally comprises a cage 12 that may house an animal 14. The cage 12 has a front wall 16 and the front wall 16 has an opening 17. The animal 14 may be a canine or other animal typically housed in a cage 12 for breeding purposes, for temporary housing or for the purposes of captivity. A housing 18 is removably coupled to the cage 12 and the housing 18 is aligned with the opening 17. Thus, the housing 18 is accessible to the animal 14 when the animal 14 is in the cage 12. The housing 18 may receive a bowl 20 thereby facilitating the animal 14 to eat from the bowl 20.

The housing 18 has a top wall 22, a bottom wall 24 and a peripheral wall 26 extending between the top wall 22 and the bottom wall 24. The peripheral wall 26 has a front side 28 and a back side 30. The front side 28 angles toward the back side 30 between the bottom wall 24 and the top wall 22 such that the housing 18 has a substantially triangular shape. The back side 30 is open to access an interior of the housing 18 and the back side 30 abuts the front wall 16 of the cage 12. The back side 30 is aligned with the opening 17 in the cage 12.

The front side 28 has an opening 32 extending therethrough. The opening 32 in the housing 18 may insertably receive the bowl 20 having the bowl 20 resting on the bottom wall 24. The opening 32 in the housing 18 has an upper bounding edge 34. The upper bounding edge 34 has a slot 36 extending upwardly therefrom.

A door 38 is hingedly coupled to the housing 18 and the door 38 is positioned on the front side 28 of the housing 38. The door 38 is positionable in a closed position such that the door 38 closes the opening 32 in the housing 18. Thus, the door 38 retains the bowl 20 within the housing 18. The door 38 is positionable in an open position such that the opening 32 in the housing 18 is exposed. The door 38 is aligned with the slot 36 when the door 38 is in the closed position. A finger may be inserted into the slot 36 thereby facilitating the door 38 to be manipulated into the open position.

A pair of rods 40 is provided and each of the rods 40 is positioned within the interior of the housing 18. Each of the rails 40 extends between the front side 28 and the back side 30. The rods 40 are spaced apart from each other. Each of the rods 40 is spaced from the bottom wall 24. The bowl 20 is positioned beneath the rods 40 to inhibit the bowl 20 from being urged upwardly within the housing 18.

A rail 42 is coupled to the back side 30 of the housing 18 and the rail 42 extends laterally along the back side 30. The rail 42 has a distal edge 44 with respect to the back side 30. The rail 42 is curved downwardly between the housing 18 and the distal edge 44. The rail 42 engages the cage 12 such that the housing 18 is inhibited from tipping away from the cage 12.

A pair of fasteners 46 is provided and each of the fasteners 46 is coupled to the housing 18. Each of the fasteners 46 engages the cage 12 such that the housing 18 is removably retained on the cage 12. Each of the fasteners 46 includes a bracket 48 that has a first portion 50 and a second portion 52. The first portion 50 forms an angle with the second portion 52. The first portion 50 of each of the brackets 48 is coupled to opposite side of the housing 18.

Each of the fasteners 46 further includes a nut 54 and a bolt 56. The bolt 56 extends through the second portion 52 of the bracket 48. The cage 12 is positioned between the bolt 56 and the second portion 52. The nut 54 engages the bolt 56 such that the cage 12 is compressed between the bolt 56 and the second portion 52.

In use, the housing 18 is coupled to the cage 12 thereby facilitating the animal 14 to access the interior of the housing 18. The door 38 is positioned in the open position and the bowl 20 is slid through the opening 32 in the front side 28. Thus, the animal 14 may eat from the bowl 20. The door 38 is positioned in the closed position to retain the bowl 20 within the housing 18. The door 38 is positioned in the open position and the bowl 20 is removed and refilled. Thus, the bowl 20 may be refilled without opening the cage 12. The housing 18 facilitates the cage 12 to remain free from spilled food when the bowl 20 is refilled. Additionally, the housing 18 facilitates the animal 14 to be fed without requiring a user to enter the cage 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animal feeding system comprising:
a cage being configured to house an animal, said cage having a front wall, said front wall having an opening; and
a housing being removably coupled to said cage, said housing being aligned with said opening wherein said housing is configured to be accessible to the animal, said housing being configured to insertably receive a bowl thereby facilitating the animal to eat from the bowl; and
a door being hingedly coupled to said housing, said door being positionable in a closed position wherein said door is configured to retain the bowl within said housing.

2. The system according to claim 1, wherein said housing has a top wall, a bottom wall and a peripheral wall extending between said top wall and said bottom wall, said peripheral wall having a front side and a back side, said front side angling toward said back side between said bottom wall and said top wall such that said housing has a substantially triangular shape, said back side being open to access an interior of said housing, said back side abutting said front wall of said cage, said back side being aligned with said opening.

3. The system according to claim 2, wherein said front side has an opening extending therethrough wherein said opening is configured to insertably receive the bowl having the bowl resting on said bottom wall, said opening having an upper bounding edge, said upper bounding edge having a slot extending upwardly therefrom.

4. The system according to claim 3, wherein said door is positioned on said front side of said housing, said door being positionable in an open position such that said opening in said housing is exposed, said door being aligned with said slot wherein said slot is configured to facilitate said door to be manipulated into said open position.

5. The system according to claim 1, further comprising:
said housing having a front side, a back side and a bottom wall; and
a pair of rods, each of said rods being positioned within an interior of said housing, each of said rails extending between said front side and said back side, said rods being spaced apart from each other, each of said rods being spaced from said bottom wall wherein each of said rods is configured to inhibit the bowl from being urged upwardly within said housing.

6. The system according to claim 2, further comprising a rail being coupled to said back side of said housing, said rail extending laterally along said back side, said rail having a distal edge with respect to said back side, said rail being curved between said housing and said distal edge, said rail engaging said cage such that said housing is inhibited from tipping away from said cage.

7. The system according to claim 1, further comprising a pair of fasteners, each of said fasteners being coupled to said housing, each of said fasteners engaging said cage such that said housing is removably retained on said cage.

8. An animal feeding system comprising:
a cage being configured to house an animal, said cage having a front wall, said front wall having an opening; and
a housing being removably coupled to said cage, said housing being aligned with said opening wherein said housing is configured to be accessible to the animal, said housing being configured to insertably receive a bowl thereby facilitating the animal to eat from the bowl, said housing having a top wall, a bottom wall and a peripheral wall extending between said top wall and said bottom wall, said peripheral wall having a front side and a back side, said front side angling toward said back side between said bottom wall and said top wall such that said housing has a substantially triangular shape, said back side being open to access an interior of said housing, said back side abutting said front wall of said cage, said back side being aligned with said opening, said front side having an opening extending therethrough wherein said opening is configured to insertably receive the bowl having the bowl resting on said bottom wall, said opening having an upper bounding edge, said upper bounding edge having a slot extending upwardly therefrom;
a door being hingedly coupled to said housing, said door being positioned on said front side of said housing, said door being positionable in a closed position such that said door closes said opening in said housing wherein said door is configured to retain the bowl within said housing, said door being positionable in an open position such that said opening in said housing is exposed, said door being aligned with said slot wherein said slot is configured to facilitate said door to be manipulated into said open position;
a pair of rods, each of said rods being positioned within said interior of said housing, each of said rails extending between said front side and said back side, said rods being spaced apart from each other, each of said rods being spaced from said bottom wall wherein each of said rods is configured to inhibit the bowl from being urged upwardly within said housing;
a rail being coupled to said back side of said housing, said rail extending laterally along said back side, said rail having a distal edge with respect to said back side, said rail being curved between said housing and said distal edge, said rail engaging said cage such that said housing is inhibited from tipping away from said cage; and
a pair of fasteners, each of said fasteners being coupled to said housing, each of said fasteners engaging said cage such that said housing is removably retained on said cage.
